(19) United States
(12) Patent Application Publication
(10) Pub. No.: US 2016/0023288 A1
(43) Pub. Date: Jan. 28, 2016

(54) CUTTING TOOL WITH SHOWER CAP

(71) Applicant: Kennametal Inc., Latrobe, PA (US)

(72) Inventors: Lewis Ray Morrison, Latrobe, PA (US); Ravishankar Iyer, North Huntingdon, PA (US)

(73) Assignee: Kennametal Inc., Latrobe, PA (US)

(21) Appl. No.: 14/338,487

(22) Filed: Jul. 23, 2014

(51) Int. Cl. B23C 5/28; B23C 5/20

(52) U.S. Cl. CPC B23C 5/28; B23C 5/20; B23C 2250/12; B23C 2270/04

(57) ABSTRACT

A cutting tool includes a cutter body and a shower cap removably secured to the cutter body. The shower cap includes a cylindrical inside reservoir surface, a cylindrical outside coolant passage surface spaced radially outward from the cylindrical inside reservoir surface, and at least one coolant passage extending radially outward from the cylindrical inside reservoir surface to the cylindrical outside coolant passage surface. The at least one coolant passage is in fluid communication with an inlet opening formed in the cylindrical inside reservoir surface and an outlet opening formed in the cylindrical outside coolant passage surface such that coolant is directed radially outward from the cylindrical inside reservoir surface through the at least one coolant passage to a vicinity of a cutting insert within an insert-receiving pocket of the cutter body.

### BACKGROUND OF THE INVENTION

1. Field of the Invention

The invention pertains to the field of cutting tools. More particularly, the invention pertains to a cutting tool with a shower cap having a cylindrical inside reservoir surface, a cylindrical outside coolant passage surface and a plurality of coolant passages extending radially outward from the cylindrical inside reservoir surface to the cylindrical outside coolant passage surface. The shower cap of the invention provides even distribution of coolant flow to the vicinity of cutting inserts mounted on the cutting tool.

2. Description of Related Art

Milling cutters for milling operations are well known. Such milling cutters typically comprise a cutter body, which is a generally circular shaped ring, having a plurality of pockets in an outer periphery thereof. A cutting insert is secured in each pocket. Each cutting insert comprises a body and at least one cutting edge. The body is secured directly in the pocket or to a cartridge, which is secured in the pocket.

In the past, it has been common to carry cutting fluid to the vicinity of the cutting inserts of the cutting tool through conduits drilled in the body of the cutting tool. Apart from the difficulty of manufacture, such systems are subject to clogging of the drilled passages, as well as to differential distribution of the cutting fluid if the conduits are not carefully designed and made, and maintained.

Accordingly, there is a need in the art for an improved cutting tool for high speed milling operations in which an even distribution of coolant flow is provided to the vicinity of the cutting inserts.

### SUMMARY OF THE INVENTION

The problem of providing an even distribution of coolant flow to the vicinity of cutting inserts mounted on the cutter body is solved by providing a shower cap with a “hub and spoke” arrangement of coolant passages that direct coolant through the coolant passages from a central reservoir to the vicinity of the cutting inserts.

In one aspect of the invention, a cutting tool comprises a cutter body having at least one insert-receiving pocket successively defined on the outer peripheral surface of the cutter body. A cutting insert is secured in the at least one insert-receiving pocket. A shower cap is removably secured to the cutter body. The shower cap includes a cylindrical inside reservoir surface, a cylindrical outside coolant passage surface spaced radially outward from the cylindrical inside reservoir surface, and at least one coolant passage extending radially outward from the cylindrical inside reservoir surface to the cylindrical outside coolant passage surface. The at least one coolant passage is in fluid communication with an inlet opening formed in the cylindrical inside reservoir surface and an outlet opening formed in the cylindrical outside coolant passage surface, wherein coolant is directed radially outward from the cylindrical inside reservoir surface through the at least one coolant passage to a vicinity of the cutting insert.

In another aspect of the invention, a shower cap for a cutting tool comprises a cylindrical inside reservoir surface, a cylindrical outside coolant passage surface spaced radially outward from the cylindrical inside reservoir surface, and at least one coolant passage extending radially outward from the cylindrical inside reservoir surface to the cylindrical outside coolant passage surface. The at least one coolant passage is in fluid communication with an inlet opening formed in the cylindrical inside reservoir surface and an outlet opening formed in the cylindrical outside coolant passage surface such that coolant is directed radially outward from the cylindrical inside reservoir surface through the at least one coolant passage to a vicinity of the cutting insert secured in an insert-receiving pocket of the cutting tool.

### BRIEF DESCRIPTION OF THE DRAWINGS

While various embodiments of the invention are illustrated, the particular embodiments shown should not be construed to limit the claims. It is anticipated that various changes and modifications may be made without departing from the scope of this invention.

FIG. 1 is an isometric view of a cutting tool according to an embodiment of the invention with the shower cap removed for clarity;

FIG. 2 is a top view of the milling cutter of FIG. 1;

FIG. 3 is an isometric of a cutting tool with the shower cap according to an embodiment of the invention;

FIG. 4 is a top view of the milling cutter of FIG. 3;

FIG. 5 is a cross sectional view through the center of the milling cutter with the shower cap taken along line 5-5 of FIG. 4;

FIG. 6 is a top view of the shower cap according to an embodiment of the invention;

FIG. 7 is a cross sectional view through the center of the shower cap taken along line 7-7 of FIG. 6; and

FIG. 8 is an isometric cross sectional view through the center of the shower cap taken along line 7-7 of FIG. 6.

### DETAILED DESCRIPTION OF THE INVENTION

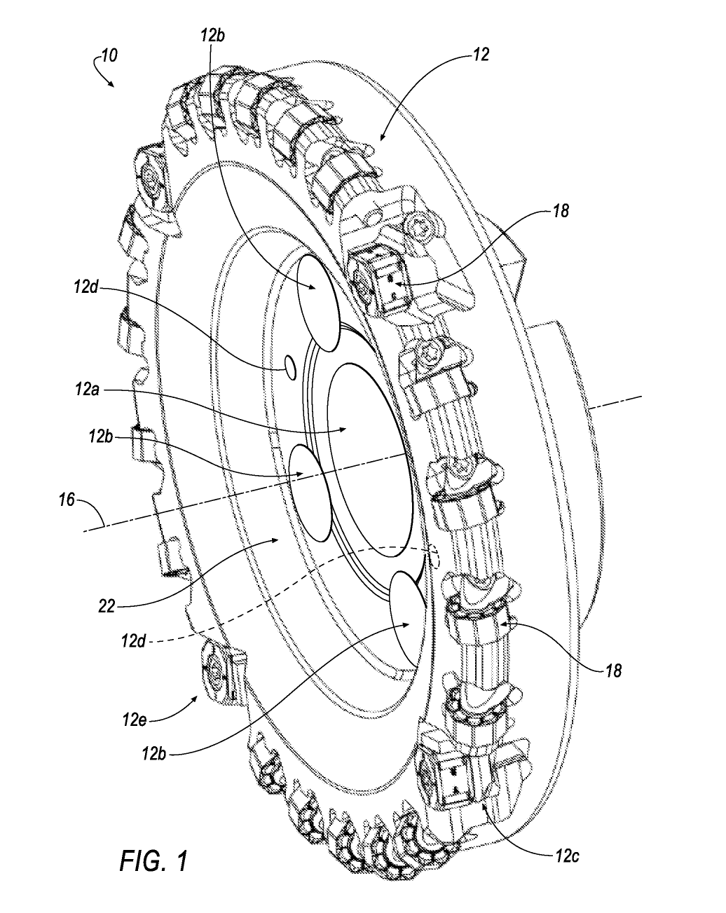

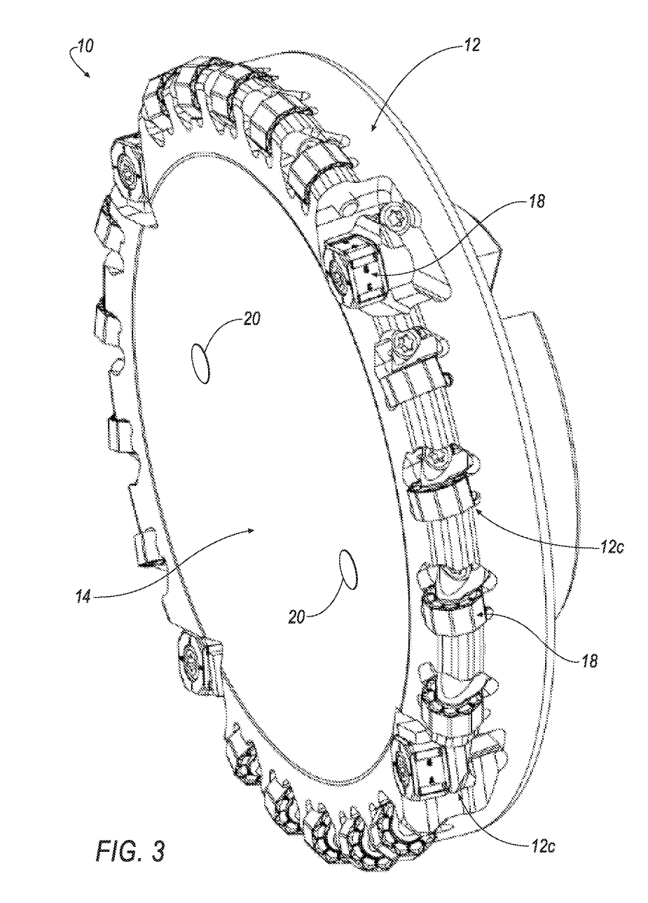

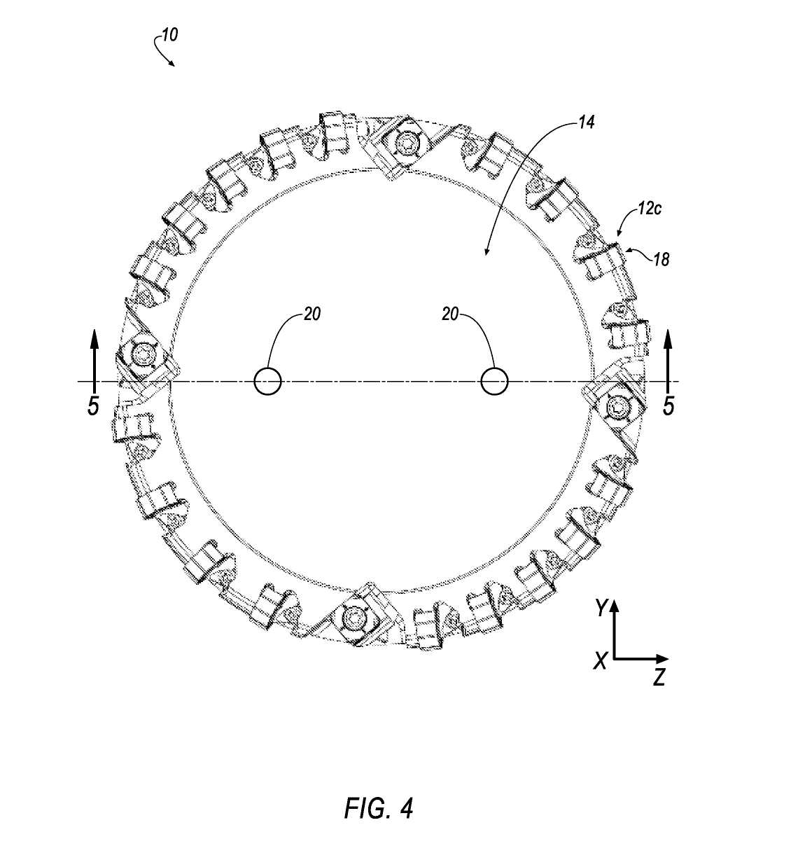

Referring now to FIGS. 1-5, wherein like numerals designate like components throughout all of the several figures, there is illustrated a cutting tool, shown generally at 10, according to a preferred embodiment of the invention. In the illustrated embodiment, the cutting tool 10 comprises a milling cutter. The milling cutter 10 is basically comprised of a cutter body 12 and a shower cap 14 provided at the center of the cutter body 12 for directing coolant from a spindle to a machine tool (not shown) in an efficient manner across the cutter body 12 to flush chips produced from milling a workpiece away from the center of the milling cutter 10.

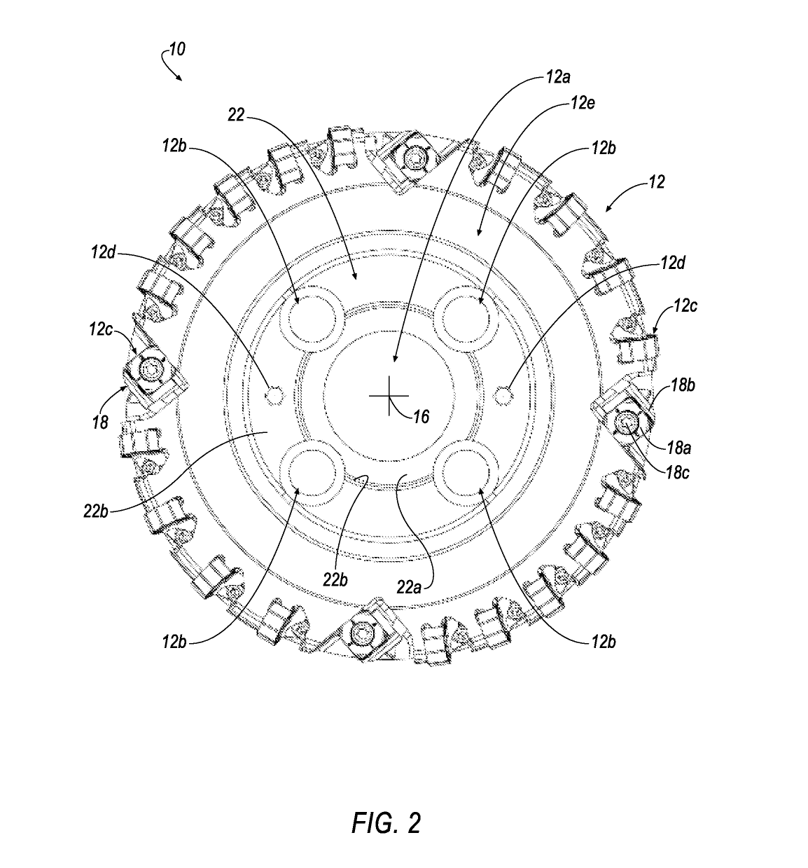

As illustrated in FIG. 2, the cutter body 12 has a central, large-diameter bore hole 12a which is assembled to a mating pilot on a rotatable adapter (not shown) and mounted to a suitable machine tool spindle (not shown). The bore hole 12a is arranged about an axis 16 of rotation of the milling cutter 10, which coincides with the axis of rotation of the milling machine to which the milling cutter 10 is mounted. The cutter body 12 also can have one or more (four in the illustrated embodiment) bolt holes 12b, which are concentric to the axis 16 and spaced at angular intervals around the central bore hole 12a. The cutter body 12 can further be provided with a key or keyway (not shown) that mates with the spindle to assist in transmitting torque from the milling machine to the milling cutter 10. The cutter body 12 also has a plurality of insert-receiving pockets 12c successively defined on the outer peripheral surface of the cutter body 12. Each of the pockets 12c is of a prescribed dimension.

Cutting inserts 18, for example, made of high-speed steel, powder metal, carbides or ceramics, are held respectively within the pockets 12c successively without interruptions or gaps therebetween. Each cutting insert 18 is comprised of a body 18a and one or more cutting edges 18b. The cutting edges can be tipped, for example, with polycrystalline diamond (PCD), cubic boron nitrate (CBN), or some other material suitable for removing material from a workpiece. The cutting inserts 18 are held in fixed relation to the pockets 12c. This can be accomplished in any suitable manner. For example, a clamp screw 18c extends through the hole the cutting insert body 18a and further into a hole (not shown) in the cutter body 12. The cutting inserts 18 are preferably adjustable relative to the cutter body 12. This can be accomplished in any suitable manner known in the art.

As shown in the illustrated embodiment, the cutting inserts 18 can be isometrically mounted and/or tangentially mounted within the pockets 12c of the cutter body 12. It will be appreciated that the invention is not limited by the number of cutting inserts 18 that are mounted in the cutter body 12, and that the principles of the invention can be applied to a cutter body 12 in which any desirable number of cutting inserts 18 can be isometrically and/or tangentially mounted therein.

The cutter body 12 also includes one or more threaded bolt holes 12d capable of receiving threaded bolts 20 for attaching the shower cap 14 to the cutter body 12. In the illustrated embodiment, the cutter body 12 includes two bolt holes 12d that are symmetrically disposed about the bore hole 12a. For example, the illustrated embodiment includes two bolt holes 12d that are disposed on opposite sides of the bore hole 12a. However, it will be appreciated that the invention in not limited by the number of bolt holes 12d, and that the invention can be practiced with a different number of bolt holes 12d that are symmetrically disposed about the bore hole 12a.

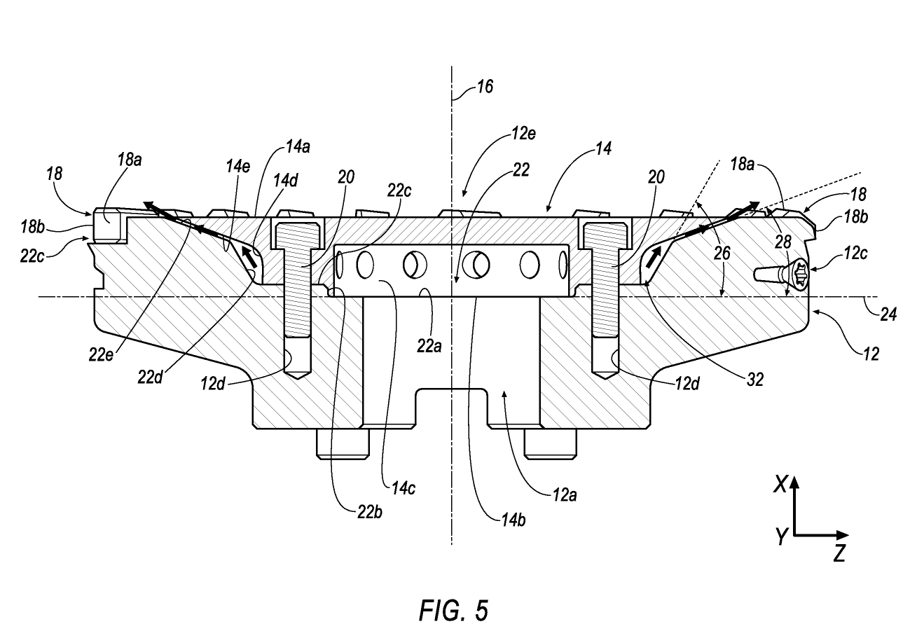

As shown in FIG. 5, the cutter body 12 also includes a recessed surface 22 in the face 12e of the cutter body 12. The recessed surface 22 includes a bottom surface 22a, a ledge 22b extending upward (in the direction of the rotational axis 16 or x-axis) from the bottom surface 22a, a planar surface 22c extending radially outward from the ledge 22b, a tapered inner ring surface 22d extending radially outward from the planar surface 22c, and a tapered outer ring surface 22e extending radially outward from the tapered inner ring surface 22d. The bottom surface 22a, the ledge 22b, the planar surface 22c, the tapered inner ring surface 22d and the tapered outer ring surface 22e are concentrically disposed about the bore hole 12a.

In the illustrated embodiment, the planar surface 22c is substantially parallel to a plane 24 that is substantially parallel to the bottom surface 22a. However, the tapered inner ring surface 22d is formed at a first angle 26 with respect to the plane 24, and the tapered outer ring surface 22e is formed at a second angle 28 with respect to the plane 24. In the illustrated embodiment, the first angle 26 is larger than the second angle 28. For example, the first angle 26 can be in the range of between about forty (40) degrees and about eighty (80) degrees, while the second angle 28 can be in the range of between about fifteen (15) degrees and about thirty (30) degrees.

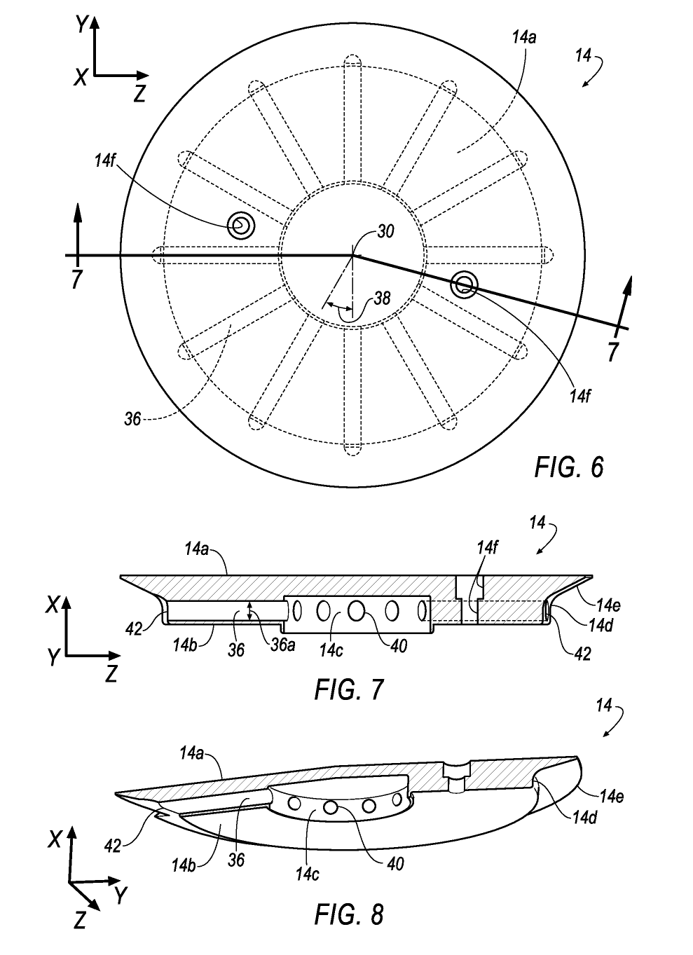

As illustrated in FIGS. 6-8, the shower cap 14 is generally circular-shaped and preferably made of, but not limited to, a non-tool steel, such as aluminum, titanium, and the like, so as to be light-weight. The shower cap 14 has a generally planar outer surface 14a, a generally planar inner surface 14b opposite the outer surface 14a, a generally cylindrical inside reservoir surface 14c, a generally cylindrical outside coolant passage surface 14d spaced radially outward from the generally cylindrical inside reservoir surface (14c), and a tapered outside surface 14e extending from the cylindrical outside coolant passage surface 14d to the planar outer surface 14a. The generally cylindrical inside reservoir surface 14c, the generally cylindrical outside coolant passage surface 14d and the tapered outside surface 14e are concentrically disposed about a central axis 30 of the shower cap 14.

Referring back to FIG. 5, the cylindrical outside coolant passage surface 14d of the shower cap 14 is adapted to be located in spaced relation to the tapered inner ring surface 22d of the recessed surface 22 of the cutter body 12. Similarly, the tapered outside surface 14e of the shower cap 14 is adapted to be located in spaced relation to the tapered outer ring surface 22e of the recessed surface 22 of the cutter body 12. This spaced relationship between the cutter body 12 and the shower cap 14 forms a channel 32 through which coolant, such as fluid, and the like, is directed from the spindle of a milling machine (not shown) to the vicinity of the cutting inserts 18. As is clearly illustrated in FIG. 5, the channel 32 is tapered to form a venturi with a high-pressure region in the vicinity of the cutting inserts 18.

Referring back to FIGS. 6-8, the shower cap 14 preferably has one or more counter-bored bolt holes 14f. The bolt holes 14f are concentric to and spaced at angular intervals around the axis 16 of rotation of the milling cutter 10. The shower cap 14 is secured to the cutter body 12 by the bolts 20 that pass through the bolt holes 14f in the shower cap 14 and are threaded into threaded bolt holes 12d in the cutter body 12. In addition, the generally cylindrical inside reservoir surface 14c of the shower cap 14 extends beyond the bottom surface 14b of the shower cap 14. The cylindrical inside reservoir surface 14c has a diameter that is slightly smaller than the diameter of the ledge 22b extending upward from the bottom surface 22a of the recessed surface 22 of the cutting body 12, thereby acts as a pilot for properly locating the shower cap 14 relative to the cutter body 12, as illustrated in FIG. 5.

One aspect of the invention is that the shower cap 14 includes a plurality of coolant passages 36 extending radially outward from the cylindrical inside reservoir surface 14c to the cylindrical outside coolant passage surface 14d. In other words, the plurality of passages 36 are disposed between the planar outer surface 14a and the planar inner surface 14b. In general, the cylindrical inside reservoir surface 14c and the plurality of coolant passages 36 define a “hub and spoke” arrangement in which coolant is directed radially outward from the cylindrical inside reservoir surface 14c, which acts as a central reservoir, through the coolant passages 36 to a vicinity of the cutting inserts 18.

In the illustrated embodiment, the shower cap 14 includes a total of twelve (12) coolant passages 36 that are equidistant from each other. For example, in the illustrated embodiment, the coolant passages 36 are equally spaced at an angle 38 of about thirty (30) degrees with respect to each other such that an imaginary line along the central axis of each coolant passage 36 intersects the central axis 30 of the shower cap 14, as shown in FIG. 6. However, it will be appreciated that the invention can be practiced with coolant passages 36 are not equidistant from each other, so long as adequate coolant is supplied in the vicinity of the cutting inserts 18.

In the illustrated embodiment, the coolant passages 36 are generally circular in cross-sectional shape having a diameter 36a, as shown in FIG. 7. It has been found that the diameter 36a of each coolant passage 36 is a function of the diameter of the shower cap 14 for suitable delivery of coolant to the vicinity of the cutting inserts 18. For example, the diameter 36a of the coolant passage 36 can be about 0.235 inches (6.0 mm) for a shower cap 14 having a diameter of about 7.874 inches (200 mm). In another example, the diameter 36a of the coolant passage 36 can be about 0.118 inches (3 mm) for a shower cap 14 having a diameter of about 4.764 inches (121 mm). The coolant passages 36 are generally circular to enable ease in manufacturing of the coolant passages 36. However, it should be appreciated that the invention is not limited by the cross-sectional shape of the coolant passages 36, and that the invention can be practiced with any desirable cross-sectional shape to deliver an adequate supply of coolant in the vicinity of the cutting inserts 18. For example, the coolant passages 36 can be oval or elliptical in cross-sectional shape, and the like.

Each coolant passage 36 is in fluid communication with an inlet opening 40 formed in the cylindrical inside reservoir surface 14c and an outlet opening 42 formed in the cylindrical outside coolant passage surface 14d. In the illustrated embodiment, the inlet opening 40 and the outlet opening 42 have the same cross-sectional shape as the corresponding coolant passage 36, i.e, a circular cross-sectional shape. However, it should be appreciated that the invention can be practiced with the inlet opening 40 and the outlet opening 42 having the same or different cross-sectional shapes as the corresponding coolant passage 36.

It has been found that the tapered outside surface 14e of the shower cap 14 causes the coolant exiting the outlet opening 42 to act as a nozzle that provides an even distribution and flow of coolant in the vicinity of the cutting inserts 18. In addition, it has been found that the cylindrical inside reservoir surface 14c of the shower cap 14 acts as a coolant reservoir that also contributes to the even distribution and flow of coolant in the vicinity of the cutting inserts 18.

The patents and publications referred to herein are hereby incorporated by reference.

Having described presently preferred embodiments the invention may be otherwise embodied within the scope of the appended claims.

What is claimed is:

1. A cutting tool, comprising:
a cutter body having at least one insert-receiving pocket successively defined on the outer peripheral surface of the cutter body;
a cutting insert secured in the at least one insert-receiving pocket; and
a shower cap removably secured to the cutter body, the shower cap including a cylindrical inside reservoir surface, a cylindrical outside coolant passage surface spaced radially outward from the cylindrical inside reservoir surface, and at least one coolant passage extending radially outward from the cylindrical inside reservoir surface to the cylindrical outside coolant passage surface, the at least one coolant passage in fluid communication with an inlet opening formed in the cylindrical inside reservoir surface and an outlet opening formed in the cylindrical outside coolant passage surface,
wherein coolant is directed radially outward from the cylindrical inside reservoir surface through the at least one coolant passage to a vicinity of the cutting insert.

2. The cutting tool of claim 1, wherein the shower cap further includes a planar outer surface, a planar inner surface opposite the outer surface, and a tapered outside surface extending from the cylindrical outside coolant passage surface to the planar outer surface.

3. The cutting tool of claim 2, wherein the cylindrical outside coolant passage surface of the shower cap is adapted to be located in a spaced relation to the cutter body, and wherein the tapered outside surface of the shower cap is adapted to be located in a spaced relation to the cutter body, thereby forming a channel for directing coolant to the vicinity of the cutting insert.

4. The cutting tool of claim 2, wherein the cylindrical inside reservoir surface, the cylindrical outside coolant passage surface and the tapered outside surface are concentrically disposed about a central axis of the shower cap.

5. The cutting tool of claim 1, wherein the shower cap includes a plurality of coolant passages.

6. The cutting tool of claim 5, wherein the coolant passages are equally spaced at an angle with respect to each other such that an imaginary line along a central axis of each coolant passage intersects a central axis of the shower cap.

7. The cutting tool of claim 1, wherein the shower cap is circular-shaped.

8. The cutting tool of claim 7, wherein the at least one coolant passage is circular in cross-sectional shape having a diameter.

9. The cutting tool of claim 8, wherein the diameter of the at least one coolant passage is a function of a diameter of the shower cap.

10. A shower cap for a cutting tool, comprising:
a cylindrical inside reservoir surface, a cylindrical outside coolant passage surface spaced radially outward from the cylindrical inside reservoir surface, and at least one coolant passage extending radially outward from the cylindrical inside reservoir surface to the cylindrical outside coolant passage surface, the at least one coolant passage in fluid communication with an inlet opening formed in the cylindrical inside reservoir surface and an outlet opening formed in the cylindrical outside coolant passage surface, wherein coolant is directed radially outward from the cylindrical inside reservoir surface through the at least one coolant passage to a vicinity of a cutting insert secured in an insert-receiving pocket of the cutting tool.

11. The shower cap of claim 10, wherein the shower cap further includes a planar outer surface, a planar inner surface opposite the outer surface, and a tapered outside surface extending from the cylindrical outside coolant passage surface to the planar outer surface.

12. The shower cap of claim 11, wherein the cylindrical outside coolant passage surface of the shower cap is adapted to be located in a spaced relation to the cutter body, and wherein the tapered outside surface of the shower cap is adapted to be located in a spaced relation to the cutter body, thereby forming a channel for directing coolant to the vicinity of the cutting insert.

13. The shower cap of claim 11, wherein the cylindrical inside reservoir surface, the cylindrical outside coolant passage surface and the tapered outside surface are concentrically disposed about a central axis of the shower cap.

14. The shower cap of claim 10, wherein the shower cap includes a plurality of coolant passages.

15. The shower cap of claim 14, wherein the coolant passages are equally spaced at an angle with respect to each other such that an imaginary line along a central axis of each coolant passage intersects a central axis of the shower cap.

16. The shower cap of claim 10, wherein the shower cap is generally circular-shaped.

17. The shower cap of claim 16, wherein the at least one coolant passage is circular in cross-sectional shape having a diameter.

18. The shower cap of claim 17, wherein the diameter of the at least one coolant passage is a function of a diameter of the shower cap.
